(19) United States
(12) Patent Application Publication
(10) Pub. No.: US 2009/0306955 A1
(43) Pub. Date: Dec. 10, 2009

(54) METHOD AND SYSTEM FOR ANALYZING ROLLING ELEMENT BEARING SYSTEMS

(75) Inventors: Louis Begin, Chandler, AZ (US); Ramprasad Santharam Korkottu, Madurai (IN); Bobby Malik, New Delhi (IN); Anand Arjunan Kutuva, Madurai (IN); Renganathan Alagarsamy, Madurai (IN); James Knorr, Tempe, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/135,769

(22) Filed: Jun. 9, 2008

(51) Int. Cl. G06F 9/45

(52) U.S. Cl. 703/22

(57) ABSTRACT

Methods and systems for analyzing rolling element bearing systems are provided. A graphical user interface (GUI) is rendered on a display device. The graphical user interface includes a plurality of characteristics of the rolling element bearing system and a plurality of widgets associated with the characteristics. An indication of a value is received with each of the widgets. Each value is representative of the respective characteristic of the rolling element bearing system. A first analysis of the rolling element bearing system is performed based on the values with a first rolling element bearing solver. A second analysis of the rolling element bearing system is performed based on the values with a second rolling element bearing solver. Results of at least one of the first and second analyses are displayed on the display device.

### TECHNICAL FIELD

The present invention generally relates to rolling element bearing analysis, and more particularly relates to methods and systems for analyzing rolling element bearing systems using a graphical user interface (GUI).

### BACKGROUND

Rolling element bearings, such as ball bearings, roller bearings, needle bearings, tapered roller bearings, spherical roller bearings, and thrust bearings, are used in a wide variety of technologies, including aerospace applications, such as turbomachinery and gearboxes. Before being manufactured and installed, such bearings are often modeled and tested on computers using complicated equations to predict, for example, performance and reliability.

The computer programs used in modern rolling element bearing analysis are referred to as “solvers.” Solvers are typically written in text-based programming languages. Fortran is particularly useful, as it is well suited to numeric analysis and scientific computation.

Although Fortran-based solvers excel at the computations used in rolling element bearing analysis, they are generally considered very difficult to use, especially because they use text-based files known as “input decks” to retrieve the specifications of the particular bearing system being tested. That is, in order to make use of a Fortran solver, the user typically has to manually create a text file that includes the inputs for the solver. If the text file is not properly formatted or uses an incorrect syntax, the solver will not operate properly, if at all.

Accordingly, it is desirable to provide a method and system for facilitating the use of text-based rolling element bearings solvers. Furthermore, other desirable features and characteristics of the present invention will become apparent from the subsequent detailed description of the invention and the appended claims, taken in conjunction with the accompanying drawings and this background of the invention.

### BRIEF SUMMARY

A method for analyzing a rolling element bearing system is provided. A graphical user interface is rendered on a display device. The graphical user interface includes a plurality of characteristics of the rolling element bearing system and a plurality of widgets associated with the characteristics. An indication of a value is received with each of the widgets. Each value is representative of the respective characteristic of the rolling element bearing system. A first analysis of the rolling element bearing system is performed based on the values with a first rolling element bearing solver. A second analysis of the rolling element bearing system is performed based on the values with a second rolling element bearing solver. Results of at least one of the first and second analyses are displayed on the display device.

A method for analyzing a rolling element bearing system is provided. A first window of a graphical user interface is displayed on a display device. The first window includes a plurality of characteristics of the rolling element bearing system and a plurality of text boxes associated with the characteristics. A value is received in each of the text boxes. Each value is representative of the respective characteristic of the rolling element bearing system. A second window of the graphical user interface is displayed on the display device. The second window includes an input deck having a selected plurality of the values associated with a Fortran-based rolling element bearing solver. An analysis of the rolling element bearing system is performed based on the selected plurality of the values with the Fortran-based rolling element bearing solver. Results of the analysis are displayed on the display device.

A computing system is provided. The computing system includes a processor, a user interface in operable communication with the processor and configured to receive user input and generate user commands, a display device in operable communication with the processor, and a computer-readable medium in operable communication with the processor. The computer readable medium has a set of instructions stored thereon that when executed by the processor cause the processor to render a graphical user interface on the display device, the graphical user interface comprising a plurality of characteristics of the rolling element bearing system and a plurality of text boxes associated with the characteristics, receive in each of the text boxes a value via user commands, each value being representative of the respective characteristic of the rolling element bearing system, perform a first analysis of the rolling element bearing system based on the values with a first rolling element bearing solver, display results of the first analysis on the display device, perform a second analysis of the rolling element bearing system based on the values with a second rolling element bearing solver, and display results of the second analysis on the display device.

### BRIEF DESCRIPTION OF THE DRAWINGS

The present invention will hereinafter be described in conjunction with the following drawing figures, wherein like numerals denote like elements, and

FIG. 1 is a block diagram of a system for analyzing rolling element bearing systems according to one embodiment of the present invention;

FIG. 2 is screen shot of a main window of a graphical user interface (GUI) which may be used in conjunction with the system of FIG. 1;

FIG. 3 is screen shot of a product detail library (PDL) window of the GUI associated with a PDL in the system of FIG. 1;

FIGS. 4-7 are screen shots of an input deck window of the GUI associated with a input deck database in the system of FIG. 1 illustrating input decks for various rolling element bearing solvers;

FIG. 8 is a screen shot of an input file window of the GUI displaying a text-based input file of a rolling element bearing solver;

FIG. 9 is a screen shot of an output deck window of the GUI displaying an output deck of a rolling element bearing solver;

FIG. 10 is a screen shot of a results window of the GUI displaying the results of a rolling element bearing solver;

FIG. 11 is a screen shot of a bearing study window of the GUI displaying a graph in accordance with an exemplary bearing study;

FIG. 12 is a screen shot of a synchronization window 100 of the GUI illustrating a method for synchronizing the inputs of multiple rolling element bearing solvers;

FIG. 13 is a screen shot of a schematic window of the GUI illustrating a schematic of a bearing system displayed over the main window of FIG. 2;

FIG. 14 is a screen shot of a coordinate system window of the GUI illustrating the various coordinate systems of the schematic of FIG. 13; and

FIG. 15 is a block diagram of an exemplary computing system on which the system for analyzing rolling element bearing system of FIG. 1 and the GUI of FIGS. 2-14 may be implemented.

### DETAILED DESCRIPTION

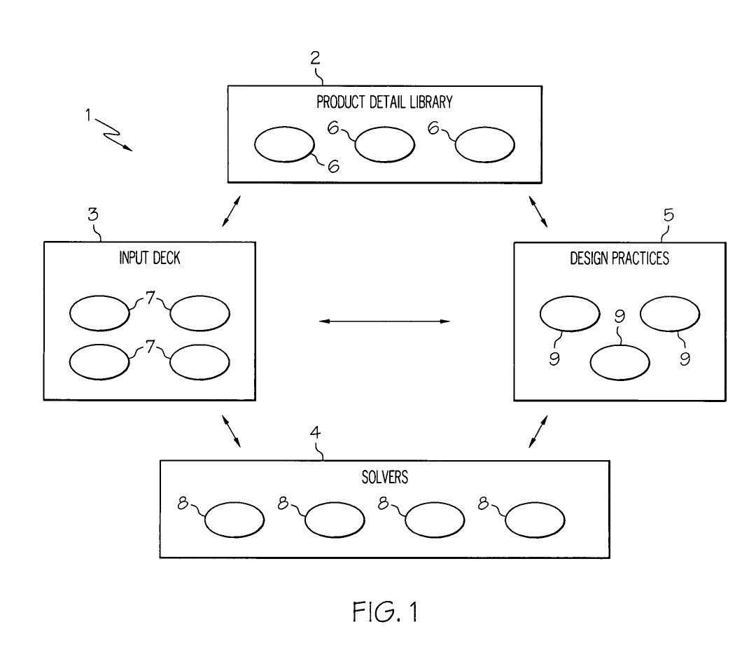

The following detailed description is merely exemplary in nature and is not intended to limit the invention or the application and uses of the invention. Furthermore, there is no intention to be bound by any expressed or implied theory presented in the preceding technical field, background, and brief summary or the following detailed description. It should also be noted that FIGS. 1-15 are merely illustrative and may not be drawn to scale.

FIGS. 1 to FIG. 15 illustrate methods and systems for analyzing rolling element bearing systems. According to one aspect of the present invention, a graphical user interface (GUI) is rendered on a display device, such as a liquid crystal display (LCD). The graphical user interface includes text describing a plurality of characteristics, attributes, details, and/or properties of the rolling element bearing system and a plurality of “widgets” (e.g., text boxes, buttons, drop-down lists, and/or check boxes) associated with the characteristics. An indication of a value is received with each of the widgets. Each value is representative of the respective characteristic of the rolling element bearing system. An analysis of the rolling element bearing system is performed based on the values with a rolling element bearing solver. Results of the analysis are displayed on the display device.

A second analysis of the rolling element bearing system may be performed based on the values with a second rolling element bearing solver. In one embodiment, the first and second rolling element bearing solvers are Fortran-based computer programs that utilize text-based input files (or input decks). The system described herein may generate a suitable text-based input file with the values entered into the GUI in a process that is transparent to the user.

The widgets on the GUI may include first, second, and third text boxes for each of the characteristics of the rolling element bearing system. The first text boxes may correspond to minimum values of the respective characteristics, the second text boxes may correspond to maximum values of the respective characteristics, and the third text boxes may correspond to nominal values of the respective characteristics.

The method may also include receiving from a user an indication of a selection on which of the minimum, maximum, and nominal values for each characteristic the first and second rolling element bearing analyses are to be based. A first input deck may be rendered on the display device that includes a first selected plurality of the text boxes associated with the first rolling element bearing analysis, which display the indicated values of the respective characteristics of the rolling element bearing system. Modifications of the respective indicated values may be received with the first selected plurality of the text boxes, and the first rolling element bearing analysis may be based on the modified values.

FIG. 1 illustrates a rolling element bearing analysis system 1, according to one embodiment of the present invention. The analysis system 1 includes, as will be described in greater detail below, a product detail library (PDL) 2, an input deck database 3, a solver database 4, and a design practice database 5. The PDL 2 includes various detail, property, and/or characteristic sets 6 about a bearing system that is to be analyzed (i.e., “the bearing system”). The input deck database 3 includes multiple sets of the characteristics from the PDL 2, each of which corresponds to a particular solver 8 within the solver database 4. The solver database 4 includes, in one embodiment, various Fortran-based rolling element bearing solvers (or simply “solvers”) 8, as are commonly understood, for numerical analysis of rolling element bearing systems. The solvers 8 may be, for example, thermal, geometric, and/or a combination thereof. As will be appreciated by one skilled in the art, the design practice database 5 includes various design practice (or bearing study) routines 9 used in further analyzing the results of the solvers 8.

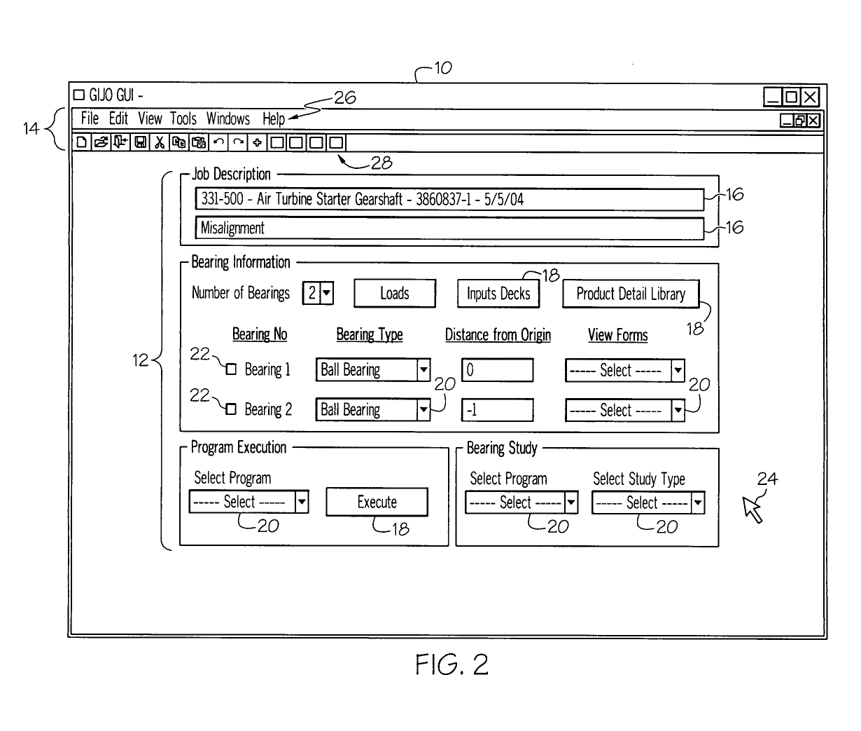

FIG. 2 illustrates a main window 10 of a GUI for a rolling element bearing analyzer according to one embodiment of the present invention. The main window 10 includes a plurality of control devices, or “widgets,” which may be divided into bearing analysis widgets 12 and program widgets 14. The bearing analysis widgets 12 include various text boxes 16, buttons 18, drop-down lists 20, and check boxes 22 all of which are selectable by a user using a cursor 24 (e.g., via a mouse), as is commonly understood. In the depicted embodiment, the bearing analysis widgets 12 are divided into a “Job Description” group, a “Bearing Information” group, a “Program Execution” group, and a “Bearing Study” group, as indicated by the text within the window 10. The bearing analysis widgets 12 allow the user to enter various types of information into the analyzer, as well as navigate to, or open, windows corresponding to the various features of the analyzer as described below. The program widgets 14 include a plurality (or an array) of pull-down menus (or drop-down lists) 26 and a toolbar 28 that the user may use to perform program level functions, such as saving and printing, as commonly understood.

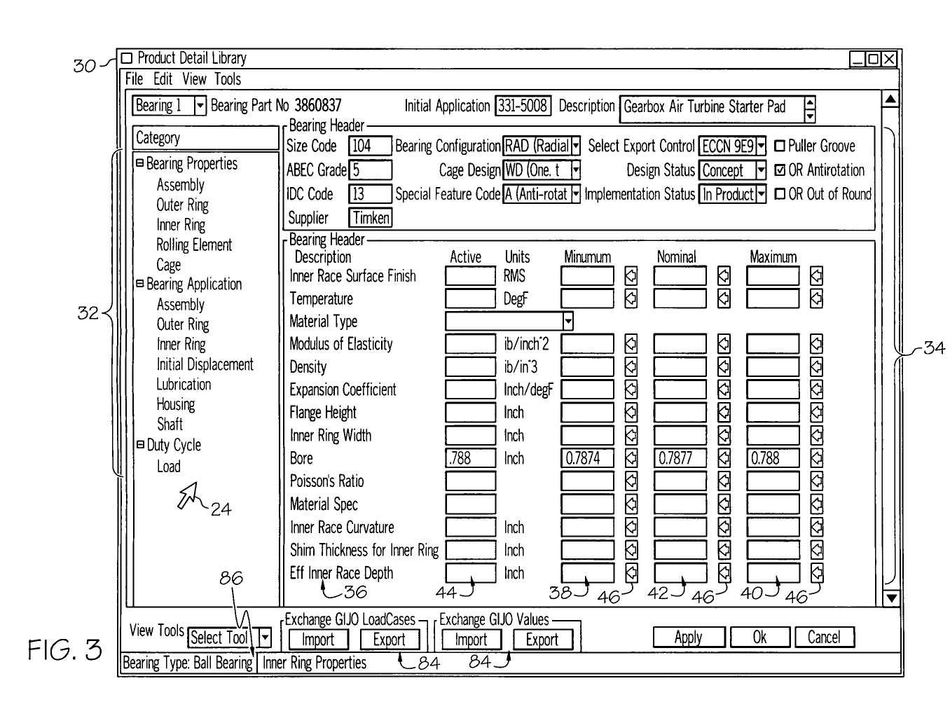

FIG. 3 illustrates a PDL window 30 which may be opened (or displayed or rendered), for example, by “clicking” the button 18 labeled “Product Detail Library” in FIG. 2. Generally, the PDL window 30 provides the user with a template in which to create a description of the bearing system to be analyzed by receiving indications of values of particular characteristics of the bearing system with widgets. The PDL window 30 includes a category tree 32 and bearing system widgets 34. In the depicted embodiment, the category tree 32 includes three main categories: Bearing Properties, Bearing Application, and Duty Cycle. As shown in FIG. 3, each of the main categories includes several sub-categories, each of which is selectable using the cursor 24. Selection of a particular sub-category causes particular bearing system widgets 34 to be displayed that are associated with the selected sub-category. In the depicted embodiment, the “Inner Ring” sub-category has been selected within the Bearing Properties category. As such, the bearing system widgets 34 shown are associated with an inner ring of a rolling element bearing, as will be appreciated by one skilled in the art.

The PDL window 30 also includes a list of multiple properties or characteristics of the bearing system that is to be analyzed. In the depicted embodiment, the characteristics are listed in a property (or characteristic) column 36. The bearing system widgets 34 include, amongst other items, text box columns 38, 40, 42, and 44, which also form rows of text boxes each aligned with a respective one of the properties 36. As indicated in FIG. 3, column 38 is a minimum value column, column 40 is a maximum value column, and column 42 is a nominal (or average) value column. Column 44 is an “active” value column that displays the value (minimum, maximum, or nominal) for the respective property 36 that is to be used in the bearing analysis. The user may select between the minimum, maximum, and nominal values for each property 36 using value selection buttons 46, each of which is associated with one of the text boxes in columns 38, 40 and 42. That is, selection of a particular value selection button 46 causes the value within that the associated text box to be displayed in the active value column 44, and slated for use in the bearing analysis as described below.

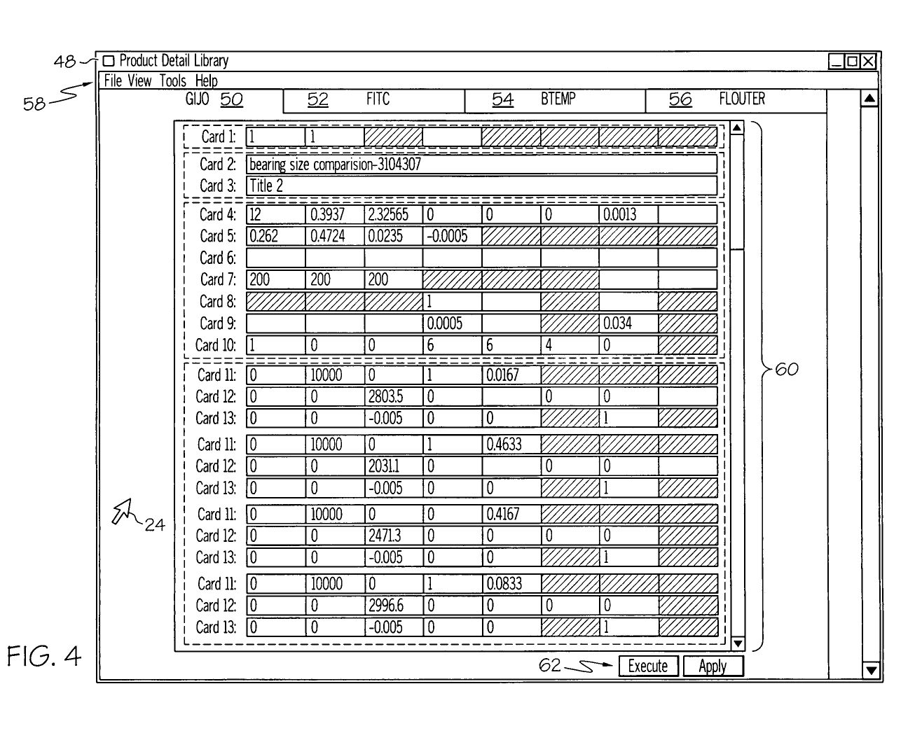

FIGS. 4-7 illustrate an input deck window 48 which may be opened, for example, by clicking the button 18 labeled “Input Decks” in FIG. 2. The input deck window 48 includes solver tabs 50, 52, 54, and 56 and a pull-down menu array 58. As labeled, each of the tabs 50-56 is associated with a particular solver 8 (FIG. 1). In particular, tab 50 is associated with a solver titled “GIJO” and is activated, or opening, within the window 48 as shown in FIG. 4. With the tab 50 activated, the window 48 displays the GIJO input deck. The GIJO input deck includes a grid, or array, of text boxes 60 and application buttons 62. As will be appreciated by one skilled in the art, each text box 60, and its particular location, corresponds to the location of the associated bearing characteristic as it appears within a text-based input deck for a particular Fortran solver, as is commonly understood. The application buttons 62 allow the user to execute the particular solver and apply any changes made to the displayed input deck.

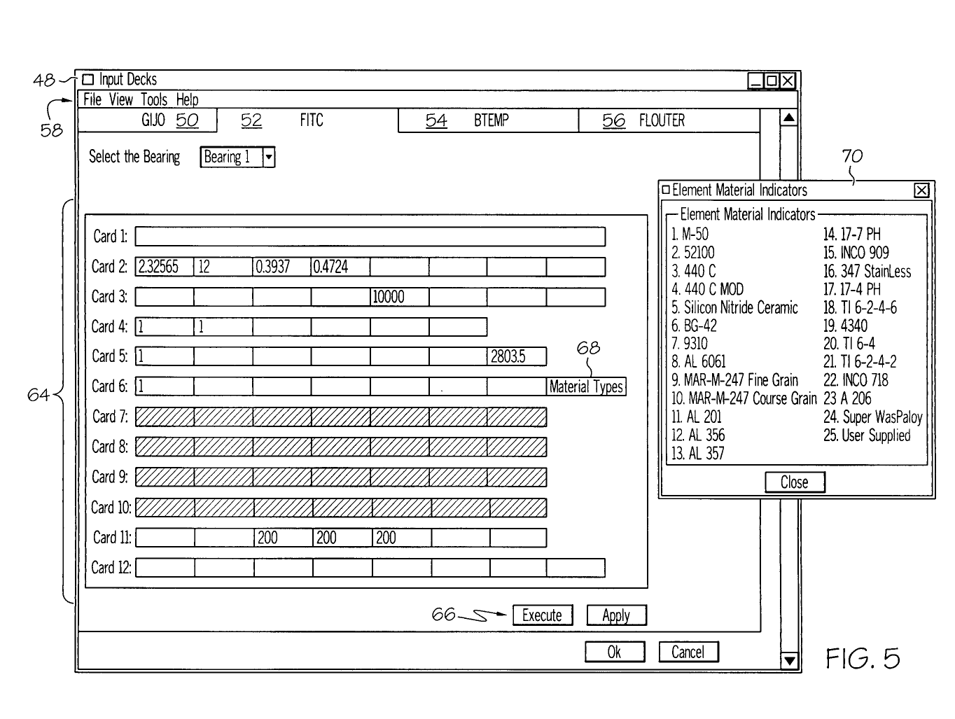

FIG. 5 illustrates the input deck window 48 with tab 52 activated, which is associated with a solver titled “FITC.” Because tab 52 is activated, a FITC input deck is displayed that includes a grid of text boxes 64, application buttons 66, and an indicator window button 68. As with the GIJO input deck, each of the text boxes 64 (and the location thereof) corresponds to an associated bearing characteristic as it appears within a text-based input deck for a particular Fortran solver. Actuation of the indicator window button 68 causes an indicator window 70 to be displayed. As illustrated, the indicator window 70 includes a list of indicators that may be used for particular inputs (or text boxes 64) of the solver and descriptions of the bearing characteristics for each indicator. In the example shown, the indicators are numerals and the associated characteristics are the materials used for particular bearings components.

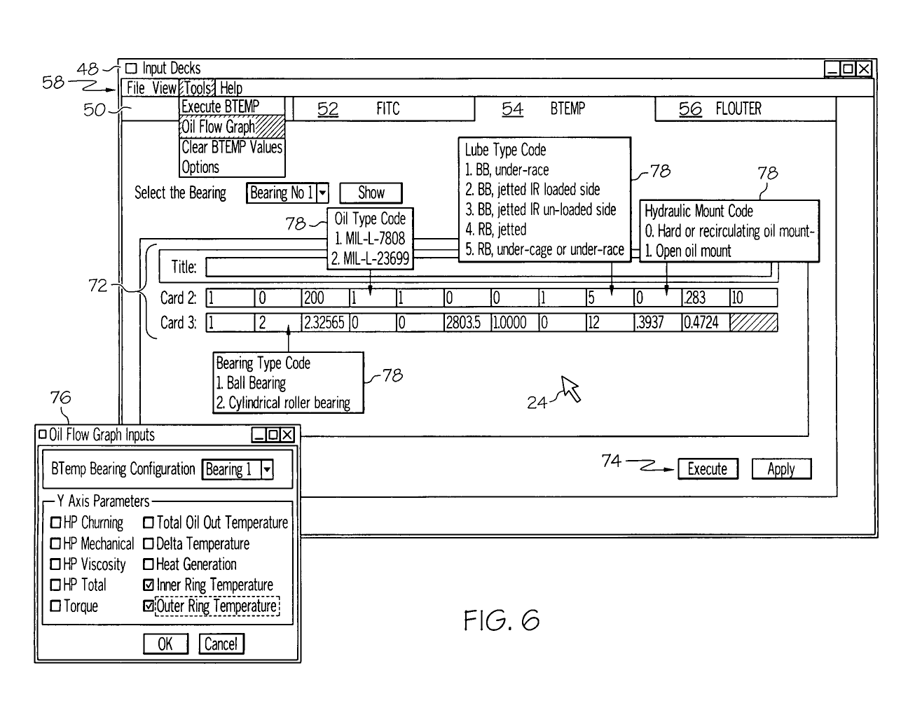

FIG. 6 illustrates the input deck window 48 with tab 54 activated, which corresponds to the displaying of an input deck for a solver titled “BTEMP.” The BTEMP input deck includes a grid of text boxes 72 and application buttons 74, similar to those described above. Also shown in FIG. 6 is a graph window 76 and “mouse-overs” 78. The graph window 76 may be activated using the pull-down menu array 58 and allow the user to create graphs using particular parameters from the input deck which may be selected using, for example, check boxes. The mouse-overs 78, as commonly understood, are small windows that may appear only when the cursor 24 is moved over an associated text box 72. In the depicted embodiment, in which multiple mouse-overs 78 are shown at once, the mouse-overs 78 each display a brief description of the bearing characteristic associated with that particular text box 72, as well as a list of possible indicators for that text box 72. Although not illustrated, similar mouse-overs may be used for the input decks shown in FIGS. 4, 5, and 7, as well as any other text boxes of the GUI described herein.

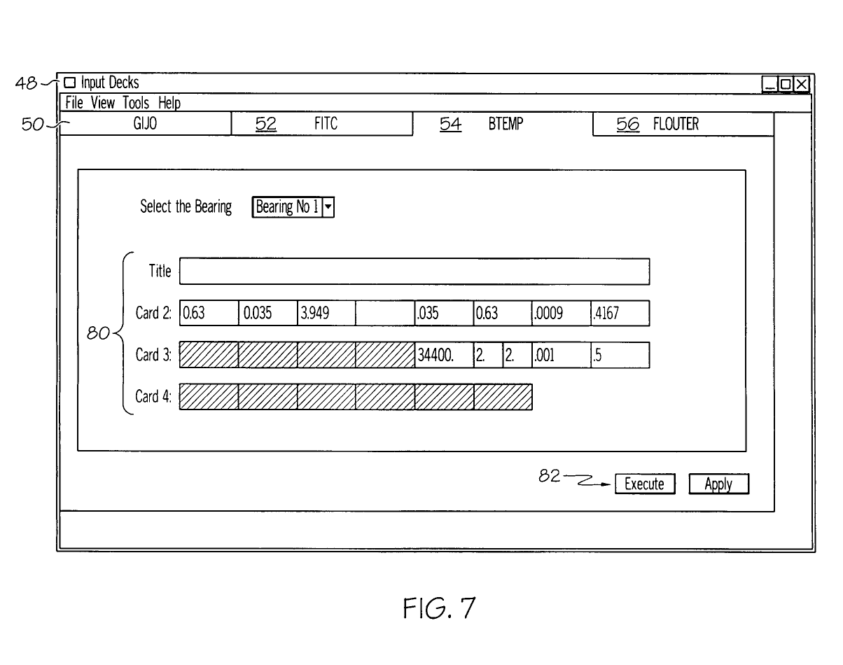

FIG. 7 illustrates the Input Deck window 48 with tab 56 activated, which corresponds to a solver titled “FLOUTER.” As such, a FLOUTER input deck is displayed including a grid of text boxes 80 and application buttons 82.

During operation, the user may first enter characteristics about the bearing system into the PDL window 30 shown in FIG. 3 in a manner consistent with the description above. As described above, the characteristics may be related to the bearing properties, the bearing application, and/or the predicted duty cycle of the bearing. The entry of the characteristics into the PDL window 30 includes, in one embodiment, minimum, maximum, and nominal values being entered in the respective columns 38, 40, and 42, as well as a selection of one of the columns, using the value selection buttons 46, for each of the characteristics 36.

In one embodiment, the PDL window 30 includes value exchange buttons 84 and an exchange drop-down list 86. When actuated by the user, the exchange buttons 84 cause the characteristics 36 (and/or the associated values) relevant to a particular solver chosen with the exchange drop-down list 86 to be loaded into the input deck for that solver. In another embodiment, the values of the relevant characteristics are automatically loaded into the input decks from the PDL.

Referring again to FIG. 4, thus when the GIJO input deck is opened on the input deck window 48, the relevant characteristic values available in the PDL appear within the appropriate text boxes 60. If characteristic in the PDL has no value entered, the corresponding text box 60 is left blank in the GIJO input deck.

As shown most clearly in FIG. 4, the text boxes 60 of the GIJO input deck are color-coded to indicate to the relative importance for each value to the GIJO solver. For example, the darkest color may indicate that those characteristics are not used (and may not be used) by the GIJO solver. The lightest shade may indicate that those characteristics may be used by the GIJO solver but are not necessary. The middle shade may indicate that those characteristics are essential for the GIJO solver (i.e., if an appropriate value is not entered into those text boxes, the solver will not function properly).

If the user wishes to change some of the values, the cursor 24 may be used to selected particular boxes and the new value may be entered. In one embodiment, such a change to a value within an input deck does not change the corresponding value in the PDL (or PDL window 30). However, as indicated in FIG. 3, the exchange buttons 84 also include “Import” buttons which do cause the values from the solver selected by the exchange drop-down list to be imported into the PDL window 30.

In the depicted embodiment, the user may execute the solvers by either actuating the button labeled “Execute” in the Program Execution group of widgets 12 on the main window 10 (i.e., after selecting the appropriate solver from the drop-down list 20 within the same group) or the “Execute” application button on the appropriate input deck (e.g., Execute application button 62 on the GIJO tab 50 in the Input Deck window 48). Although not shown, the execution of the solvers may also be initiated using the pull-down menu array 26 on the main window 10.

In order to make use of the Fortran solvers, text-based input files, as are commonly understood, may be generated from the inputs decks shown in FIGS. 4-7 in a process that may go unseen by the user. These text files may be used in the calculations carried out by the solvers.

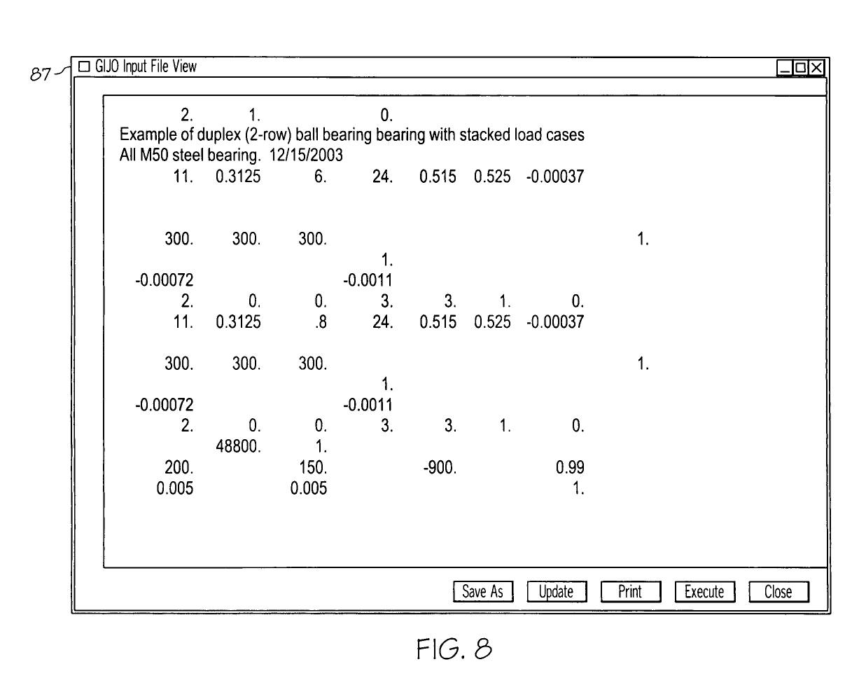

However, in one embodiment, the user is provided with the ability to view the text-based input file(s). FIG. 8 illustrates an input file window 87 displaying a text-based input file for the GIJO solver. As previously alluded to, the input file is essentially a word processing document with characters and values entered in specific locations. If the characters are not properly located within the file, or use improper syntax, the respective solver will not operate properly.

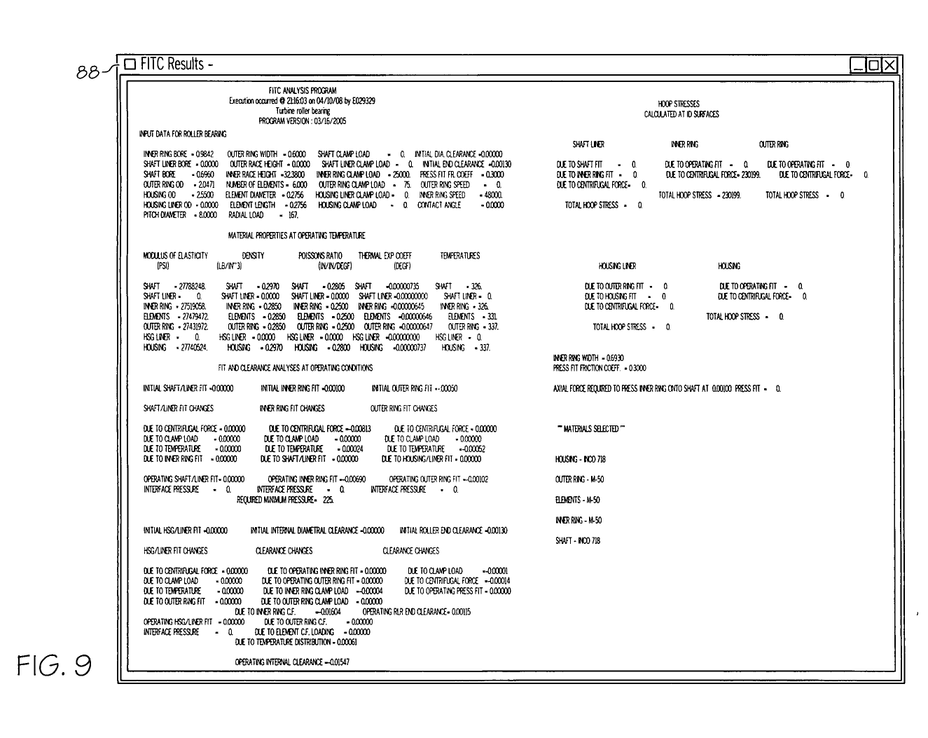

After the solver(s) have been executed, the user may select to view multiple forms of the results of the calculations performed using the pull-down menu array 26 shown in FIG. 2. FIG. 9 illustrates an output deck window 88 for the FITC solver. The output deck window 88 displays a text file that includes the raw numbers generated from the operation of the FITC solver. One skilled in the art will appreciate that this text file is similar to the output typically generated by such a Fortran solver.

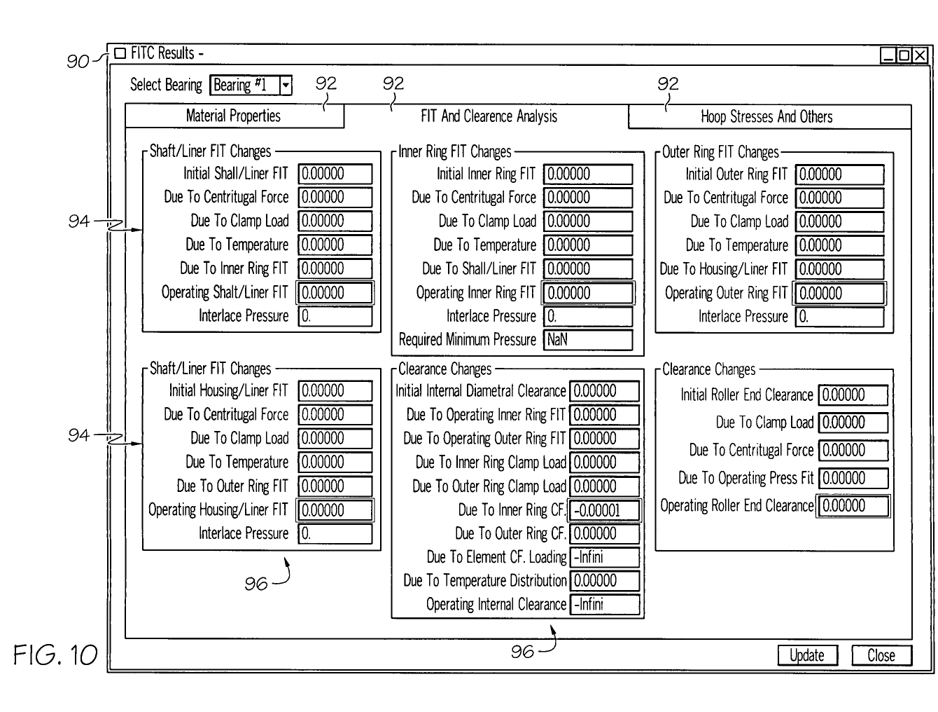

FIG. 10 illustrates a results window 90 for the FITC solver. The results window includes multiple results tabs 92, and each result tab 92 displays various result descriptors 94 and result values 96 (shown in text boxes). The results shown may be organized in such that the results on each result tab 92 are related in such a way to facilitate the analysis of the bearing system. For example, on the result tab 92 displayed in FIG. 9, the results are organized into groups that are labeled (e.g., “Shaft/Liner FIT Changes” and “Clearance Changes”).

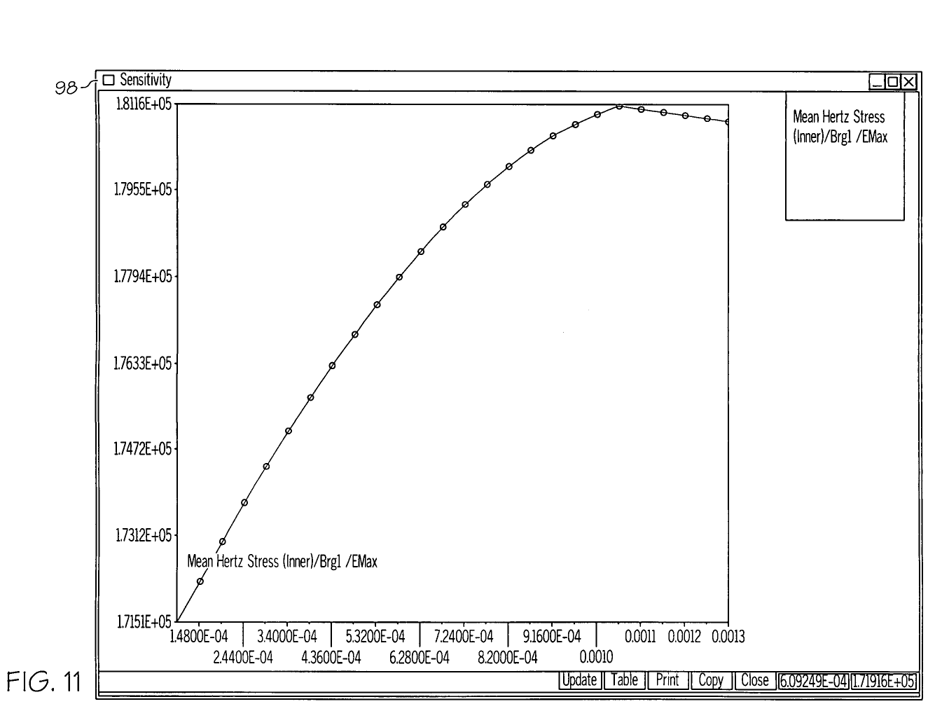

FIG. 11 illustrates a bearing study (or design practice) window 98 displaying a graph. As will also be appreciated by one skilled in the art, bearing studies, or design practices 9 (FIG. 1), are used to comprehend the ways into changes to particular characteristics affect the performance of the bearing system. The example shown in FIG. 10 may be referred to as a “parametric” study in which the mean Hertz stress on the inner ring of a bearing plotted as the internal diametral clearance of a bearing is varied. Referring again to FIG. 2, the bearing study window is opened, for example, using the drop-down lists 20 within the Bearing Study group of widgets 12 on the main window 10, as shown in FIG. 1.

It should be understood that the bearing study shown in FIG. 11 is intended merely as an example, as the bearing studies used by different manufacturers vary greatly. Other bearing study techniques that may be uses are “design of experiments,” Federated Intelligent Product Environment (FIPER) optimizations, and “study tables,” as are commonly understood.

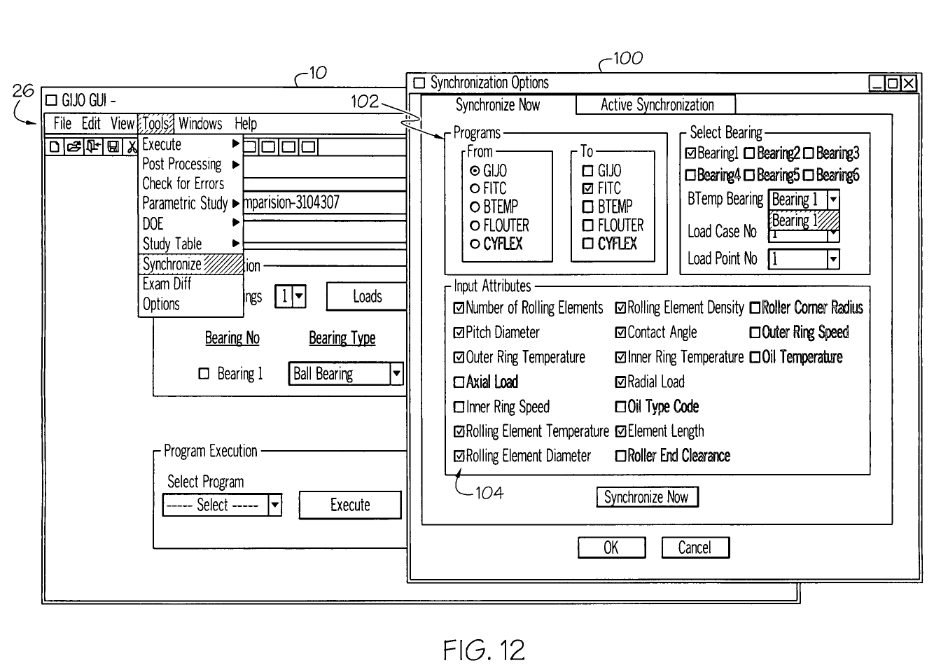

Referring to FIG. 12, if the user wishes to transfer input values between input decks of various solvers, a “Synchronize” command may be selected from the pull-down menu array 26 on the main window 10. Selection of the Synchronize command causes a synchronization window 100 to be displayed. The synchronization window 100 includes, amongst other features, a program selection section 102 and an input attribute section 104. The program selection section 102 includes various widgets (e.g., check boxes) for selecting the input decks from which and to which the values are to be transferred. The input attribute section 104 includes widgets (e.g., check boxes) for selecting the particular characteristics or attributes for which the values are to be transferred between the selected solvers. In the example shown in FIG. 12, the user has selected to transfer the input values from the GIJO input deck (FIG. 4) to the FITC input deck (FIG. 5) and to transfer all applicable values except for “Inner Ring Speed.”

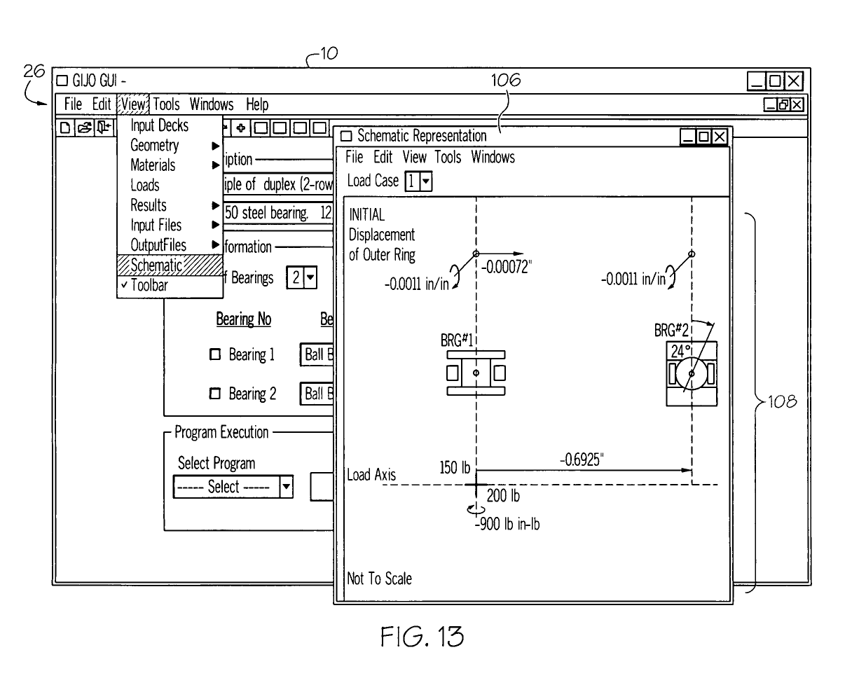

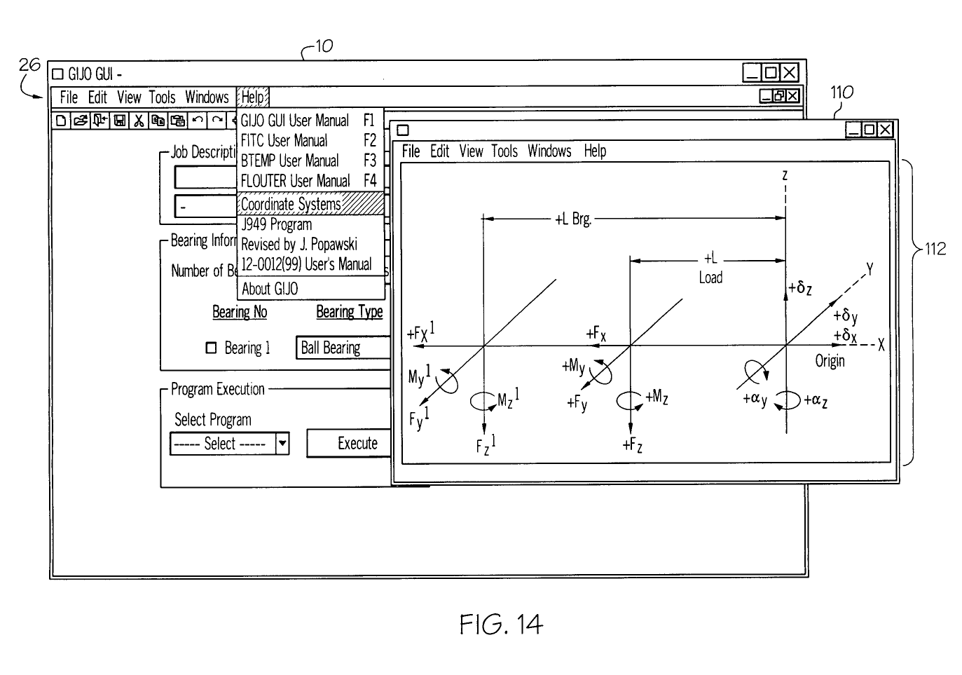

Referring to FIG. 13, if the user wishes to view a schematic illustration of the bearing system, a “Schematic” command may be selected from the pull-down menu array 26 on the main window 10. Selection of the Schematic command causes a schematic window 106 to be displayed. As illustrated, the schematic window 106 includes a schematic illustration 108 of the bearing system. As will be appreciated by one skilled in the art, the schematic illustration 108 includes visual representations of the system components, as well as the values of selected bearing system characteristics as stored in the PDL 2 (FIG. 1), to assist the user in comprehending the bearing system. As shown in FIG. 14, a coordinate system window 110 may also be opened via a “Coordinate Systems” command on the pull-down menu array 26 on the main window 10. The coordinate system window 110 includes a diagram 112 of the coordinate systems used in the schematic illustration of FIG. 13 to further assist in the user's comprehension of the bearing system.

One advantage of the systems and method described above is that the care required in generating the inputs for a Fortran solver is greatly reduced, as the syntax of the inputs is greatly simplified as is the overall formatting of the input decks required by the user. As a result, the time required to generate the input decks is greatly reduced and the efficiency with which bearing systems can be modeled and analyzed is significantly improved. Another advantage is that sets of inputs may be entered in one location of the GUI (e.g., the PDL window 30 or one of the input decks) and used by multiple rolling element bearing solvers after being easily transferred (e.g., via the exchange or synchronize commands) to other locations (e.g., other input decks), further reducing the time required to generate input decks. A further advantage is that the schematic may be generated using inputs already entered into the system, which quickly allows the user to visualize the bearing system and check for obvious errors in the inputs, such as incorrect signs (e.g., + or −) on values. A yet further advantage is because of the multiple columns of values and the value selection buttons within the PDL window, the user may easily toggle the values used by the solvers between the minimum, maximum, and nominal values. As a result, the user may easily determine the extent to which the minimum and maximum values will affect the solvers results.

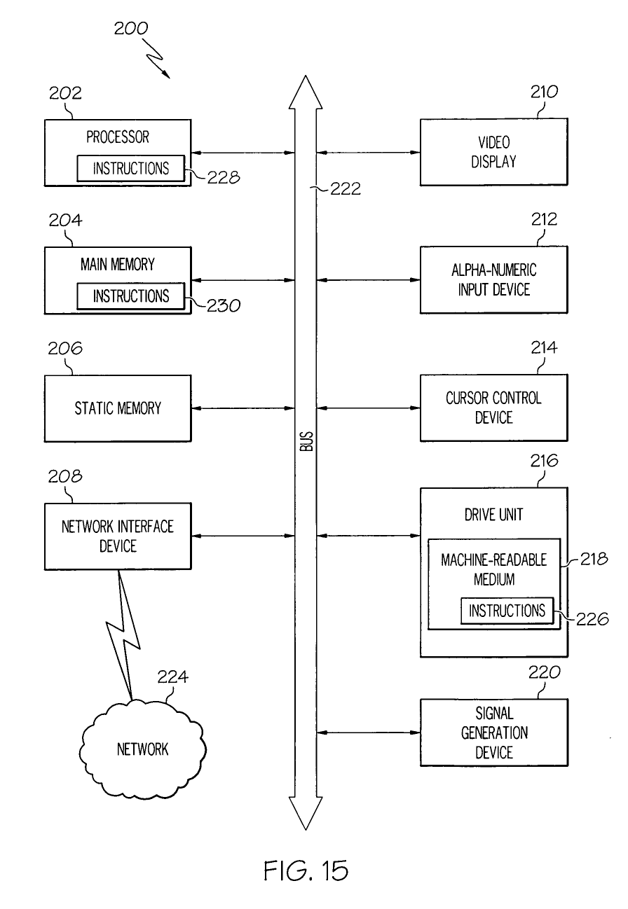

FIG. 15 schematically illustrates a computing system 200 on which the systems and methods described above may be implemented. The computing system 200 includes a processor 202, a main memory 204, a static memory 206, a network interface device 208, a video display 210, an alpha-numeric input device 212, a cursor control device 214, a drive unit 216 including a machine-readable medium 218, and a signal generation device 220. All of the components of the computing system 200 are interconnected by a bus 222. The computing system 200 may be connected to a network 224 through the network interface device 208.

The processor 202 may be any one of numerous known general-purpose microprocessors or an application specific processor that operates in response to program instructions. The processor 202 may be implemented using a plurality of digital controls, including field programmable gate arrays (FPGAs), application specific integrated circuits (ASICs), discrete logic, microprocessors, microcontrollers, and digital signal processors (DSPs), or combinations thereof.

The machine-readable medium 218 includes a set of instructions 226, which may be partially transferred to the processor 202 and the main memory 204 through the bus 222. The processor 202 and the main memory 204 may also have separate internal sets of instructions 228 and 230 stored thereon. The main memory 204, static memory 206, the machine-readable medium 218, and/or the instructions 228 and 230 may include random access memory (RAM) and read-only memory (ROM). It will be appreciated that this is merely exemplary of one scheme for storing operating system software and software routines, and that various other storage schemes may be implemented.

The video display (or display device) 210 may be, for example, a liquid crystal display (LCD) device or a cathode ray tube (CRT) monitor. The alpha-numeric input device 212 may be a keyboard and the cursor control device 214 may be a mouse, as commonly understood.

Although not shown in FIG. 1, the system 1 may also include a central database to which details of a bearing system may be saved. Additionally, the central database may include the details of commonly used bearing system components, or bearing system components currently in production, that the user may wish to consider using in the bearing system. Thus, once the user decides which bearing system component he or she would like to use, the details (i.e., the product detail library) of that component may be downloaded for use in analysis. Additionally, the central database may include a search feature that allows users to search for bearing system components based on, for example, the type of component or a range of values of a particular characteristic of the component (e.g., flange height, inner race curvature, etc.).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for analyzing a rolling element bearing system comprising:
rendering a graphical user interface on a display device, the graphical user interface comprising a plurality of characteristics of the rolling element bearing system and a plurality of widgets associated with the characteristics;
receiving with each of the widgets an indication of a value, each value being representative of the respective characteristic of the rolling element bearing system;
performing a first analysis of the rolling element bearing system based on the values with a first rolling element bearing solver;
performing a second analysis of the rolling element bearing system based on the values with a second rolling element bearing solver; and
displaying results of at least one of the first and second analyses on the display device.

2. The method of claim 1, wherein the first and second rolling element bearing solvers are Fortran-based computer programs.

3. The method of claim 1, wherein the plurality of widgets comprises first, second, and third text boxes for each of the characteristics of the rolling element bearing system.

4. The method of claim 3, wherein the first text boxes each correspond to a minimum value of the respective characteristic, the second text boxes each correspond to a maximum value of the respective characteristic, and the third text boxes each correspond to a nominal value of the respective characteristic.

5. The method of claim 4, further comprising receiving from a user an indication of a selection on which of the minimum, maximum, and nominal values for each characteristic the first and second rolling element bearing analyses are to be based.

6. The method of claim 5, further comprising rendering a first input deck on the display device, the first input deck comprising a first selected plurality of the text boxes associated with the first rolling element bearing analysis, the first selected plurality of the text boxes displaying said indicated values of the respective characteristics of the rolling element bearing system.

7. The method of claim 6, further comprising receiving modifications of the respective indicated values with the first selected plurality of the text boxes, and wherein the first rolling element bearing analysis is based on said modified indicated values.

8. The method of claim 7, further comprising rendering a second input deck on the display device, the second input deck comprising a second selected plurality of the text boxes associated with the second rolling element bearing analysis, the second selected plurality of the text boxes displaying said indicated values of the respective characteristics of the rolling element bearing system and said modified indicated values for the characteristics of the rolling element bearing system associated with both of the first and second rolling element bearing analyses.

9. The method of claim 2, further comprising:
generating a schematic representation of the rolling element bearing system based on the values; and
displaying the schematic representation on the display device.

10. The method of claim 1, further comprising performing at least one bearing study on the results of the at least one of the first and second bearing analyses, the at least one bearing study being one of a parametric study, a design of experiments, an optimization, and a study table.

11. A method for analyzing a rolling element bearing system comprising:
displaying a first window of a graphical user interface on a display device, the first window comprising a plurality of characteristics of the rolling element bearing system and a plurality of text boxes associated with the characteristics;
receiving in each of the text boxes a value, each value being representative of the respective characteristic of the rolling element bearing system;
displaying a second window of the graphical user interface on the display device, the second window comprising an input deck having a selected plurality of the values associated with a Fortran-based rolling element bearing solver;
performing an analysis of the rolling element bearing system based on the selected plurality of the values with the Fortran-based rolling element bearing solver; and
displaying results of the analysis on the display device.

12. The method of claim 11, further comprising:
displaying a third window of the graphical user interface on the display device, the third window comprising a second input deck having a second selected plurality of the values associated with a second Fortran-based rolling element bearing solver;
performing a second analysis of the rolling element bearing system based on the second selected plurality of the values with the second Fortran-based rolling element bearing solver; and
displaying results of the second analysis on the display device.

13. The method of claim 12, further comprising receiving modifications of the values in the text boxes, and wherein the first and second rolling element bearing analyses are based on said modified values.

14. The method of claim 11, further comprising:
generating a visual schematic representation of the rolling element bearing system based on the values; and
displaying the visual schematic representation of the rolling element bearing system on the display device.

15. The method of claim 11, wherein the selected plurality of the values are displayed in an arrangement associated with a text-based Fortran input deck for the Fortran-based rolling element bearing solver.

16. A computing system comprising:
a processor;
a user interface in operable communication with the processor and configured to receive user input and generate user commands;
a display device in operable communication with the processor; and
a computer-readable medium in operable communication with the processor, the computer readable medium having a set of instructions stored thereon that when executed by the processor cause the processor to:
render a graphical user interface on the display device, the graphical user interface comprising a plurality of characteristics of the rolling element bearing system and a plurality of text boxes associated with the characteristics;
receive in each of the text boxes a value via user commands, each value being representative of the respective characteristic of the rolling element bearing system;
perform a first analysis of the rolling element bearing system based on the values with a first rolling element bearing solver;
display results of the first analysis on the display device;
perform a second analysis of the rolling element bearing system based on the values with a second rolling element bearing solver; and
display results of the second analysis on the display device.

17. The method of claim 16, wherein the plurality of text boxes comprises first, second, and third text boxes for each of the characteristics of the rolling element bearing system.

18. The method of claim 17, wherein the first text boxes each correspond to a minimum value of the respective characteristic, the second text boxes each correspond to a maximum value of the respective characteristic, and the third text boxes each correspond to a nominal value of the respective characteristic.

19. The method of claim 18, wherein the method further comprises receiving from a user an indication of a selection on which of the minimum, maximum, and nominal values for each characteristic the first and second rolling element bearing analyses are to be based.

20. The method of claim 19, further comprising rendering a first input deck on the display device, the first input deck comprising a first selected plurality of the text boxes associated with the first rolling element bearing analysis, the first selected plurality of the text boxes displaying said indicated values of the respective characteristics of the rolling element bearing system.
